(19) United States
(12) Patent Application Publication
(10) Pub. No.: US 2009/0133713 A1
(43) Pub. Date: May 28, 2009

(54) Multilayer structural body and method for cleaning the same

(75) Inventors: Tadahiro Ohmi, Miyagi (JP); Akinobu Teramoto, Miyagi (JP); Hitoshi Morinaga, Miyagi (JP); Yukio Kishi, Miyagi (JP); Hiromichi Ohtaki, Miyagi (JP); Yoshihumi Tsutai, Miyagi (JP)

Correspondence Address: FOLEY AND LARDNER LLP;SUITE 500, 3000 K STREET NW, WASHINGTON, DC, 20007, US

(73) Assignees: Tohoku University; Nihon Ceratec Co., Ltd.

(21) Appl. No.: 11/988,648

(22) PCT Filed: Jul. 12, 2006
(86) PCT No.: PCT/JP2006/313831

§ 371 Date: Jan. 11, 2008

(30) Foreign Application Priority Data
Jul. 14, 2005 (JP) 2005-206071

(51) Int. Cl. B08B 3/12; B32B 5/16

(52) U.S. Cl. 134/1; 428/323; 428/325

(57) ABSTRACT

It has been difficult to provide a large-sized ceramic member quickly and economically. A multilayer structure is produced by forming a ceramic film on a base which is made of a material that can be shaped comparatively easily. The ceramic film is formed by a plasma spraying method, CVD method, PVD method, sol-gel method or the like. Alternatively, the ceramic film may be formed by a method combined with a spray deposit film.

### TECHNICAL FIELD

This invention relates to a structural body used as a component or a member for use in an environment where high cleanness is required, such as in the dry process for electronic devices, the manufacture of medical supplies, or the processing/manufacture of foodstuffs, and to a cleaning method therefor.

### BACKGROUND ART

The miniaturization of the design rule of semiconductors has been advanced following the improvement in integration thereof and thus it has been required to reduce the allowable size and amount of adhering substance and metal contaminants. Further, in terms of sanitation of medical supplies, foodstuffs, and so on, it is required to reduce adhering substance and metal contaminants. Normally, structural bodies that hate metal contaminants or the like employ ceramics as members thereof. Particularly, structural bodies forming semiconductor and liquid-crystal manufacturing apparatuses tend to increase in size following the increase in size of wafers and panels.

Herein, an explanation will be given using a microwave plasma processing apparatus as an example of a semiconductor manufacturing apparatus. The microwave plasma processing apparatus comprises a process chamber, a holding stage disposed in the process chamber for holding a processing substrate, a shower plate provided at a position facing the processing substrate, a cover plate disposed on the shower plate, and a radial line slot antenna provided on the cover plate. The shower plate is in the form of a plate made of alumina and having a number of gas ejection holes, while the cover plate is also made of alumina. Further, it is considered that the inner wall of the process chamber is also made of alumina or is made of yttria in terms of corrosion resistance to plasma.

It has been pointed out that, in the case where various members in a semiconductor manufacturing apparatus are formed of a ceramic such as alumina as described above, the ceramic members are subjected to formation of organic contaminants, metal contaminants, and contaminants due to adhesion of particles in various manufacturing processes such as baking, grinding, and polishing. If a wafer or a liquid crystal panel is brought into direct contact with such a member with the contaminants remaining thereon, the contaminants are accumulated on the surface of the wafer or the liquid crystal panel to cause a circuit failure. It has also been pointed out that the impurities diffuse into the wafer due to the contact.

Therefore, it is necessary to suppress adhesion of particles and metals as much as possible in order to obtain semiconductors or liquid crystal panels with high yield.

The requirement for high cleanness of various members forming semiconductor manufacturing apparatuses tends to be further increased in future along with the increase in size of wafers and liquid crystal panels.

The present inventors have previously proposed a method of cleaning ceramic members forming various members of a semiconductor manufacturing apparatus in Patent Document 1. According to this cleaning method, it is possible to clean the surface of the ceramic member. Specifically, the ceramic member cleaning method proposed in Patent Document 1 performs precleaning of the ceramic member by at least one method among wiping with a highly clean sponge or brush, ultrasonic cleaning with a degreaser, immersion cleaning with an organic chemical, ultrasonic cleaning with ozone water, SPM cleaning, and HF/HNO₃ cleaning.

Further, this cleaning method performs, after the precleaning, cleaning with ozone water, ultrasonic cleaning with pure water containing hydrogen and controlled at an alkaline pH, and cleaning with at least one selected from HF, SPM, HPM, and HNO₃/HF and finally performs ultrasonic cleaning using one kind selected from pure water containing hydrogen, ozone water, and ultrapure water.

By cleaning the ceramic member using the foregoing cleaning method, the number of particles having a particle size of 0.2 μm or more on the surface of the ceramic member can be reduced to two or less per mm².

Therefore, since the surface of the ceramic member cleaned according to Patent Document 1 is extremely clean, it is possible to significantly improve the yield of wafers or liquid crystal panels.

As described above, along with the increase in size of semiconductor manufacturing apparatuses, various ceramic members for use in those semiconductor manufacturing apparatuses unavoidably increase in size. However, since a ceramic member is manufactured by baking at a high temperature of 1000° C. or more, shrinkage unavoidably occurs during the baking. As a result, it becomes more difficult to achieve dimensional accuracy as the ceramic member increases in size. Further, as the ceramic member increases in size, the baking is required for a longer time. Therefore, it is difficult to manufacture a ceramic member that is large in size and still has precise dimensions, in a short time and economically.

Therefore, the current situation is that it is practically difficult to quickly respond to the requirement for increase in size using a ceramic member alone.
Patent Document 1: Japanese Unexamined Patent Application Publication (JP-A) No. 2004-279481
Patent Document 2: Japanese Unexamined Patent Application Publication (JP-A) No. H5-339699
Patent Document 3: Japanese Unexamined Patent Application Publication (JP-A) No. H5-202460

### DISCLOSURE OF THE INVENTION

### Problem to be Solved by the Invention

It is an object of this invention to provide, in response to the requirement for increase in size of semiconductor manufacturing apparatuses and so on, a structural body that exhibits functions and effects, for example, insulating properties, corrosion resistance in etching environment, and weight lightening, equivalent to a ceramic member and has an extremely clean surface.

It is another object of this invention to provide a structural body having a multilayer structure in order to reduce a burden in the case where a member of a semiconductor manufacturing apparatus or the like is formed by a ceramic member alone.

It is still another object of this invention to provide a multilayer structural body having a surface layer that is not subjected to stripping or the like even if cleaning is performed for increasing the cleanness.

It is a further object of this invention to provide a method of depositing a ceramic layer with a high adhesion strength as a surface layer forming the surface of a multilayer structural body.

It is another subject of this invention to provide a cleaning method for obtaining a ceramic surface with a high cleanness.

### Means for Solving the Problem

The present inventors have made a study of a structural body with a multilayer structure instead of forming a ceramic member for a semiconductor manufacturing apparatus by a ceramic member alone. Specifically, the present inventors have examined a multilayer structural body in which a film (specifically a ceramic film) is deposited on a base member, and have found that, by improving a deposition method and a cleaning method for the ceramic film deposited on the base member, there is obtained a structural body having a surface equivalent to that of the ceramic member shown in Patent Document 1.

According to a first aspect of the present invention, there is provided a multilayer structural body, which comprises a base member and a film formed on a surface of the base member, wherein the number of adhering particles having a particle size of 0.2 μm or more is two or less per mm² on the film.

According to a second aspect of the present invention, there is provided the multilayer structural body of the first aspect, wherein the base member is formed of a ceramic, a metal, or a composite material thereof.

According to a third aspect of the present invention, there is provided the multilayer structural body of the second aspect, wherein the film is a ceramic film.

According to a fourth aspect of the present invention, there is provided the multilayer structural body of the third aspect, wherein the ceramic film is a sprayed film deposited on the base member by spraying.

According to a fifth aspect of the present invention, there is provided the multilayer structural body of the fourth aspect, wherein the ceramic film is deposited on the base member by a CVD method.

According to a sixth aspect of the present invention, there is provided the multilayer structural body mentioned above, wherein the ceramic film is deposited on the base member by a PVD method.

According to a seventh aspect of the present invention, there is provided the multilayer structural body mentioned above, wherein the ceramic film is deposited on the base member by a sol-gel method.

According to an eighth aspect of the present invention, there is provided the multilayer structural body mentioned above, wherein the ceramic film is formed on a sprayed film by any one of the methods according to claims 5 to 7

According to a ninth aspect of the present invention, there is provided the multilayer structural body mentioned above, wherein the ceramic film has an adhesion strength of 10 MPa or more.

According to a tenth aspect of the present invention, there is provided a method of cleaning a multilayer structural body. The multilayer structural body includes a base member and a film formed on a surface of the base member. The method includes a step of cleaning the film by applying an ultrasonic wave of 5 W/cm² or more and less than 30 W/cm².

According to an eleventh aspect of the present invention, there is provided the method mentioned above, wherein the ultrasonic cleaning is performed using a nozzle-type cleaning apparatus.

According to a twelfth aspect of the present invention, there is provided the method according to the tenth or the eleventh aspect, wherein the ultrasonic cleaning is performed by preparing a solution in which a gas selected from the group consisting of hydrogen, ammonia, and carbon dioxide is dissolved in ultrapure water, and applying the ultrasonic wave to the solution.

### EFFECT OF THE INVENTION

According to this invention, by providing a laminated structural body having a ceramic layer at its surface, there is an effect that it is possible to quickly and economically cope with an increase in size of a structural member. Further, since high-cleanness cleaning can be performed for the ceramic layer deposited on a base member, high cleanness can be maintained. Further, since the adhesion strength of the deposited ceramic layer is high, even if an ultrasonic wave of 5 W/cm² or more and 30 W/cm² or less is applied in the high-cleanness cleaning, there is no occurrence of stripping or the like.

### BRIEF DESCRIPTION OF THE DRAWINGS

FIG. 1 is a relational diagram between the number of particles and the ultrasonic output in high-cleanness cleaning of Y₂O₃ films obtained by various manufacturing methods according to this invention.

FIG. 2 is a sectional view of a multilayer structural body according to a first embodiment of this invention.

FIG. 3 is a sample shape diagram for measuring the number of adhering particles.

FIG. 4 is a schematic diagram explaining an atmosphere-open thermal CVD apparatus that forms a multilayer structural body according to a second embodiment of this invention.

FIGS. 5(a) and (b) are diagrams, in imitation of scanning electron microscope (SEM) photographs, showing a section and a plane of a multilayer structural body formed by the CVD apparatus shown in FIG. 3.

FIGS. 6(a) and (b) are diagrams explaining, in order of process, a sol-gel method that forms a multilayer structural body according to a third embodiment of this invention.

### DESCRIPTION OF SYMBOLS

10 base member
11 ceramic layer
21 flowmeter
23 evaporator
25 nozzle
27 heater
29 heater
31 spray gun
33 ceramic precursor
35 oven

### BEST MODE FOR CARRYING OUT THE INVENTION

Hereinbelow, embodiments of this invention will be described.

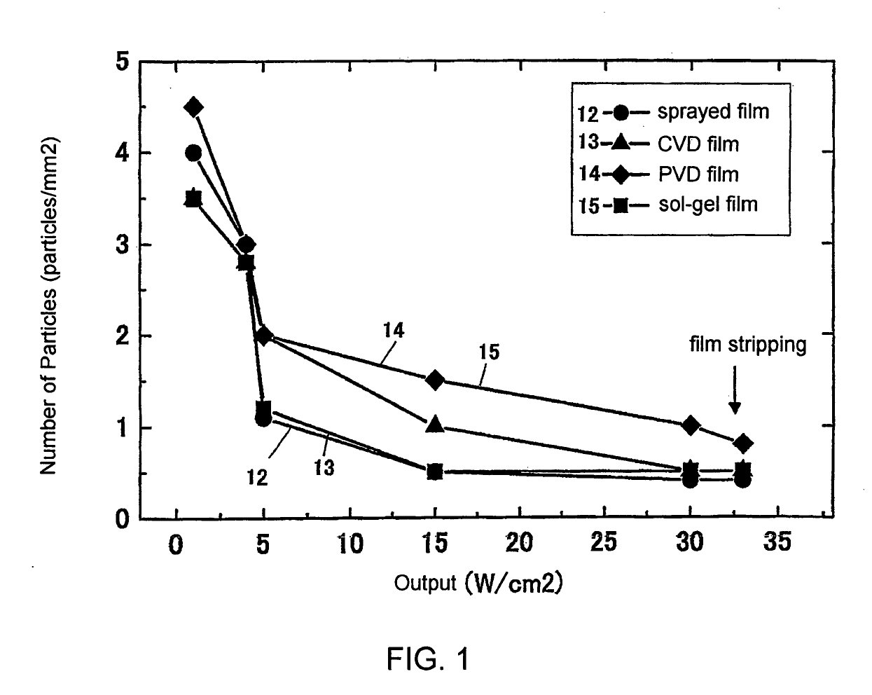

FIG. 1 is a relational diagram between the number of particles and the ultrasonic output in high-cleanness cleaning of Y₂O₃ films obtained by various manufacturing methods according to this invention. As shown in FIG. 1, since the adhesion strength of each deposited ceramic layer is high, even if an ultrasonic wave of 5 W/cm² or more and 30 W/cm² or less is applied for high-cleanness cleaning, there is no occurrence of stripping or the like.

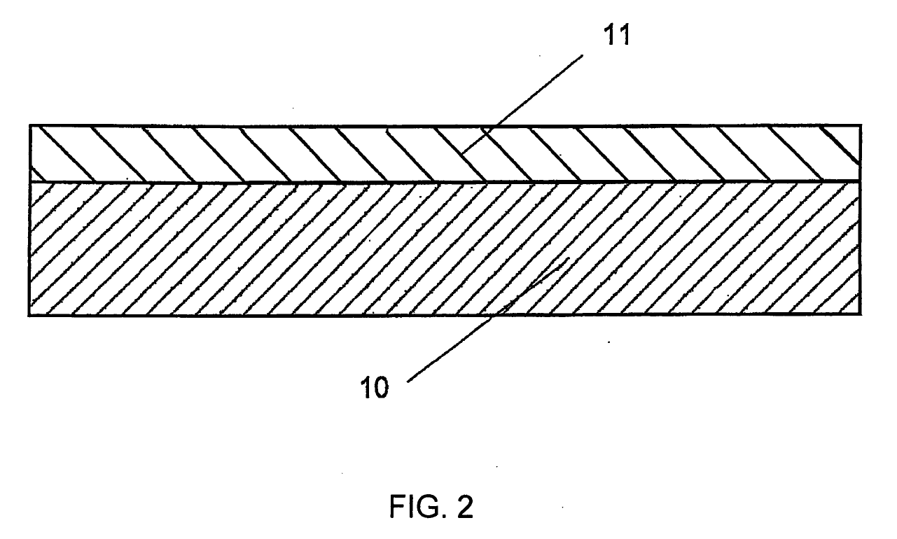

Referring to FIG. 2, a multilayer structural body according to a first embodiment of this invention comprises, for example, a base member 10 and a ceramic layer 11 in the form of yttria deposited by plasma spraying (i.e. a plasma-sprayed Y₂O₃ layer) on the surface of the base member. Herein, an aluminum alloy with a diameter of 40 mm and a thickness of 3 mm is used as the base member 10 and the plasma-sprayed film is formed as the ceramic layer 11 on the surface of the base member 10. The illustrated plasma-sprayed film is the Y₂O₃ layer having a thickness of 200 μm. A spray apparatus described, for example, in Patent Document 2 or Patent Document 3 can be used for the plasma spraying.

A ceramic film is preferably Y₂O₃, Al₂O₃, MgO, or a compound thereof for a semiconductor manufacturing apparatus in terms of plasma resistance.

In the illustrated example, the ceramic layer 11 is directly formed on the surface of the aluminum alloy base member 10. However, the surface of the aluminum alloy base member 10 may be anodized to thereby form an anodized film and then a plasma-sprayed film may be formed. That is, a layer formed on the base member 10 may be a composite layer.

Normally, in the case of a plasma-sprayed film formed by plasma spraying, a dense ceramic layer cannot be obtained and, therefore, since adhering substances and so on caused by manufacturing processes remain in pores by a normal cleaning method, it is unsuitable for forming a member that requires high quality. However, according to the study by the present inventors, there has been obtained a multilayer structural body that can sufficiently withstand use as a member of a semiconductor manufacturing apparatus without causing film stripping or defect, by a developed cleaning method.

Quantitative evaluation of particles was carried out in the following manner.

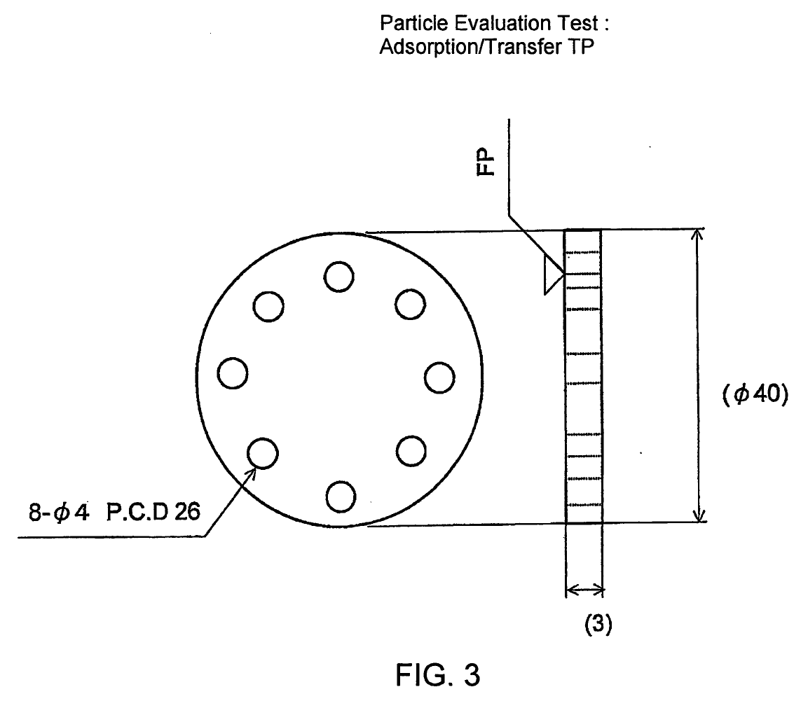

Using a sample with a shape shown in FIG. 3, a mirror-finished ceramic film surface was, before and after cleaning, subjected to adsorption/transfer onto a silicon wafer at 0.107 Pa (about 0.8 mTorr) or less for 2 minutes, thereby transferring adhering particles on the surface of the sample onto the wafer side. Thereafter, the particles on the silicon wafer were measured by a particle counter (Surfscan6420 manufactured by Tencor).

The cleaning was performed such that miscellaneous adhering substances that could be visually observed were first removed by ultrasonic cleaning in pure water and then cleaning comprising first to fourth cleaning processes was applied to the sample precleaned using a clean-room sponge and a degreaser. The first cleaning process is an organic substance removal process, wherein ozone-dissolved ultrapure water is effective. The second process is a process of cleaning by selecting at least one from methods of cleaning by a nozzle-type ultrasonic cleaning apparatus (abbreviated as nozzle) using ultrapure water in which a gas selected from the group consisting of hydrogen, ammonia, and carbon dioxide is dissolved and cleaning by a bath-type ultrasonic cleaning apparatus (abbreviated as bath) using the same ultrapure water. The third process is a metal removal process and the fourth process is a rinsing process which is rinsing with only ultrapure water or with ultrapure water in which a gas selected from the group consisting of hydrogen, ammonia, and carbon dioxide is dissolved.

Tables 1 to 4 below show the particle measurement results along with ultrasonic cleaning conditions applied to Examples of this invention, respectively.

TABLE 1

| | Film | | | Ultrasonic | | Number of | Film Defect | | |
|---|---|---|---|---|---|---|---|---|---|
| | Forming | Base | | Cleaning | Output | Particles | ∘: no | | |
| No. | Method | Member | Film | Method | W/cm² | particles/mm² | x: yes | Classification | Remarks |
| 1 | spraying | Al alloy | Y₂O₃ | nozzle type | 1 | 4 | ∘ | Comparative | |
| | | | | | | | | Example | |
| 2 | | | | | 4 | 3.0 | ∘ | | |
| 3 | | | | | 5 | 1.1 | ∘ | Example | |
| 4 | | | | | 15 | 0.5 | ∘ | | |
| 5 | | | | | 30 | 0.4 | ∘ | | |
| 6 | | | | | 33 | 0.4 | x | Comparative | film stripping |
| | | | | | | | | Example | |
| 7 | | | | bath type | 1 | 5.0 | ∘ | | |
| 8 | | | | | 4 | 3.0 | ∘ | | |
| 9 | | | | | 5 | 1.5 | ∘ | Example | |
| 10 | | | Al₂O₃ | nozzle | 4 | 3.0 | ∘ | Comparative | |
| | | | | type | | | | Example | |
| 11 | | | | | 5 | 1.3 | ∘ | Example | |
| 12 | | | | | 15 | 1.1 | ∘ | | |
| 13 | | | | | 30 | 1.0 | ∘ | | |
| 14 | | | | | 33 | 1.0 | x | Comparative | film stripping |
| | | | | | | | | Example | |
| 15 | | | | bath type | 1 | 4.5 | ∘ | | |
| 16 | | | | | 4 | 3.0 | ∘ | | |
| 17 | | | | | 5 | 1.5 | ∘ | Example | |
| 18 | | ceramic | Y₂O₃ | nozzle | 4 | 3.0 | ∘ | Comparative | |
| | | | | type | | | | Example | |
| 19 | | | | | 5 | 1.1 | ∘ | Example | |
| 20 | | | | | 15 | 0.7 | ∘ | | |
| 21 | | | | bath type | 4 | 3.0 | ∘ | Comparative | |
| | | | | | | | | Example | |
| 22 | | | | | 5 | 1.5 | ∘ | Example | |
| 23 | | metal- | Y₂O₃ | nozzle | 4 | 6.0 | ∘ | Comparative | |
| | | ceramic | | type | | | | Example | |
| 24 | | composite | | | 5 | 2.0 | ∘ | Example | |
| 25 | | material | | | 15 | 1.5 | ∘ | | |
| 26 | | | | | 30 | 1.0 | ∘ | | |
| 27 | | | | | 33 | 1.0 | x | Comparative | film stripping |
| | | | | | | | | Example | |

TABLE 2

| | Film | | | Ultrasonic | | Number of | Film Defect | | |
|---|---|---|---|---|---|---|---|---|---|
| | Forming | Base | | Cleaning | Output | Particles | ∘: no | | |
| No. | Method | Member | Film | Method | W/cm² | particles/mm² | x: yes | Classification | Remarks |
| 28 | CVD | ceramics | Y₂O₃ | nozzle | 1 | 3.5 | — | Comparative | |
| | | | | type | | | | Example | |
| 29 | | | | | 4 | 2.8 | ∘ | | |
| 30 | | | | | 5 | 2.0 | ∘ | Example | |
| 31 | | | | | 15 | 1.0 | ∘ | | |
| 32 | | | | | 30 | 0.5 | ∘ | | |
| 33 | | | | | 33 | 0.5 | x | Comparative | film stripping |
| | | | | | | | | Example | |
| 34 | | | | bath type | 4 | 3.0 | ∘ | | |
| 35 | | | | | 5 | 2.0 | ∘ | Example | |
| 36 | | | Al₂O₃ | nozzle | 4 | 2.5 | ∘ | Comparative | |
| | | | | type | | | | Example | |
| 37 | | | | | 5 | 2.0 | ∘ | Example | |
| 38 | | | | | 15 | 0.5 | ∘ | | |
| 39 | | Si | Y₂O₃ | | 5 | 1.0 | ∘ | | |
| 40 | | | | | 15 | 0.5 | ∘ | | |
| 41 | | SUS | Y₂O₃ | | 4 | 2.5 | ∘ | Comparative | |
| | | | | | | | | Example | |
| 42 | | | | | 5 | 1.5 | ∘ | Example | |
| 43 | | | | | 15 | 0.5 | ∘ | | |
| 44 | | | | bath type | 4 | 4.0 | ∘ | Comparative | |
| | | | | | | | | Example | |
| 45 | | | | | 5 | 2.0 | ∘ | Example | |
| 46 | | | | nozzle | 4 | 3.0 | ∘ | Comparative | |
| | | | | type | | | | Example | |
| 47 | | | | | 5 | 1.5 | ∘ | Example | |
| 48 | | | | | 15 | 0.5 | ∘ | | |

TABLE 3;

| | Film | | | Ultrasonic | | Number of | Film Defect | | |
|---|---|---|---|---|---|---|---|---|---|
| | Forming | Base | | Cleaning | Output | Particles | ∘: no | | |
| No. | Method | Member | Film | Method | W/cm² | particles/mm² | x: yes | Classification | Remarks |
| 49 | PVD | ceramics | Y₂O₃ | nozzle | 1 | 4.5 | ∘ | Comparative | |
| | | | | type | | | | Example | |
| 50 | | | | | 4 | 3.0 | ∘ | | |
| 51 | | | | | 5 | 2.0 | ∘ | Example | |
| 52 | | | | | 15 | 1.5 | ∘ | | |
| 53 | | | | | 30 | 1.0 | ∘ | | |
| 54 | | | | | 33 | 0.8 | x | Comparative | film stripping |
| | | | | | | | | Example | |
| 55 | | | | bath type | 4 | 3.5 | ∘ | | |
| 56 | | | | | 5 | 2.0 | ∘ | Example | |
| 57 | | | Al₂O₃ | nozzle | 4 | 3.0 | ∘ | Comparative | |
| | | | | type | | | | Example | |
| 58 | | | | | 5 | 2.0 | ∘ | Example | |
| 59 | | | | | 15 | 1.0 | ∘ | | |
| 60 | | Si | Y₂O₃ | | 5 | 1.0 | ∘ | | |
| 61 | | | | | 15 | 0.5 | ∘ | | |
| 62 | | Al alloy | | | 4 | 2.5 | ∘ | Comparative | |
| | | | | | | | | Example | |
| 63 | | | | | 5 | 1.5 | ∘ | Example | |
| 64 | | | | | 15 | 0.5 | ∘ | | |
| 65 | | | | bath type | 4 | 4.0 | ∘ | Comparative | |
| | | | | | | | | Example | |
| 66 | | | | | 5 | 2.0 | ∘ | Example | |
| 67 | | | | nozzle | 4 | 3.0 | ∘ | Comparative | |
| | | | | type | | | | Example | |
| 68 | | | | | 5 | 1.5 | ∘ | Example | |
| 69 | | | | | 15 | 0.5 | ∘ | | |

TABLE 4

| | Film | | | Ultrasonic | | Number of | Film Defect | | |
|---|---|---|---|---|---|---|---|---|---|
| | Forming | Base | | Cleaning | Output | Particles | ∘: no | | |
| No. | Method | member | Film | Method | W/cm² | particles/mm² | x: yes | Classification | Remarks |
| 70 | sol-gel | ceramics | Y₂O₃ | nozzle | 1 | 3.5 | ∘ | Example | |
| 71 | | | | type | 4 | 2.8 | ∘ | Comparative | |
| | | | | | | | | Example | |
| 72 | | | | | 5 | 1.2 | ∘ | Example | |
| 73 | | | | | 15 | 0.5 | ∘ | | |
| 74 | | | | | 30 | 0.5 | ∘ | | |
| 75 | | | | | 33 | 0.5 | x | Comparative | film stripping |
| | | | | | | | | Example | |
| 76 | | | | bath type | 4 | 3.0 | ∘ | | |
| 77 | | | | | 5 | 1.5 | ∘ | Example | |
| 78 | | | Al₂O₃ | nozzle | 4 | 2.5 | ∘ | Comparative | |
| | | | | type | | | | Example | |
| 79 | | | | | 5 | 1.5 | ∘ | Example | |
| 80 | | | | | 15 | 1.0 | ∘ | | |
| 60 | | SUS | Y₂O₃ | | 5 | 1.5 | ∘ | | |
| 61 | | | | | 15 | 0.8 | ∘ | | |
| 62 | | Al alloy | | | 4 | 2.5 | ∘ | Comparative | |
| | | | | | | | | Example | |
| 63 | | | | | 5 | 1.5 | ∘ | Example | |
| 64 | | | | | 15 | 0.5 | ∘ | | |
| 65 | | | | bath type | 4 | 3.5 | ∘ | Comparative | |
| | | | | | | | | Example | |
| 66 | | | | | 5 | 1.5 | ∘ | Example | |
| 67 | | | Al₂O₃ | nozzle | 4 | 2.5 | ∘ | Comparative | |
| | | | | type | | | | Example | |
| 68 | | | | | 5 | 2.0 | ∘ | Example | |
| 69 | | | | | 15 | 0.7 | ∘ | | |

Referring to Tables 1 to 4 above, in the case of an ultrasonic output of 4 W/cm² or less, remaining particles are large in number and thus it is not suitable for use in a highly clean environment such as a semiconductor manufacturing apparatus. In the case of an ultrasonic output of 5 W/cm² or more, the number of particles is reduced to 2/mm². Further, it has been found that the nozzle-type method is effective for reducing particles as compared with the bath-type method as the ultrasonic method. However, in the case of an ultrasonic output exceeding 30 W/cm², failure such as stripping occurred at a portion of the ceramic film.

It was confirmed that, as a result of actual measurement by a measuring method according to JIS H8666, the average adhesion force of a Y₂O₃ film as a plasma-sprayed film 11 on an aluminum alloy base member 10 was 11 MPa or more. Further, even when a composite film was formed on a base member 10, a plasma-sprayed film forming an uppermost layer had an adhesion strength of 12 MPa or more.

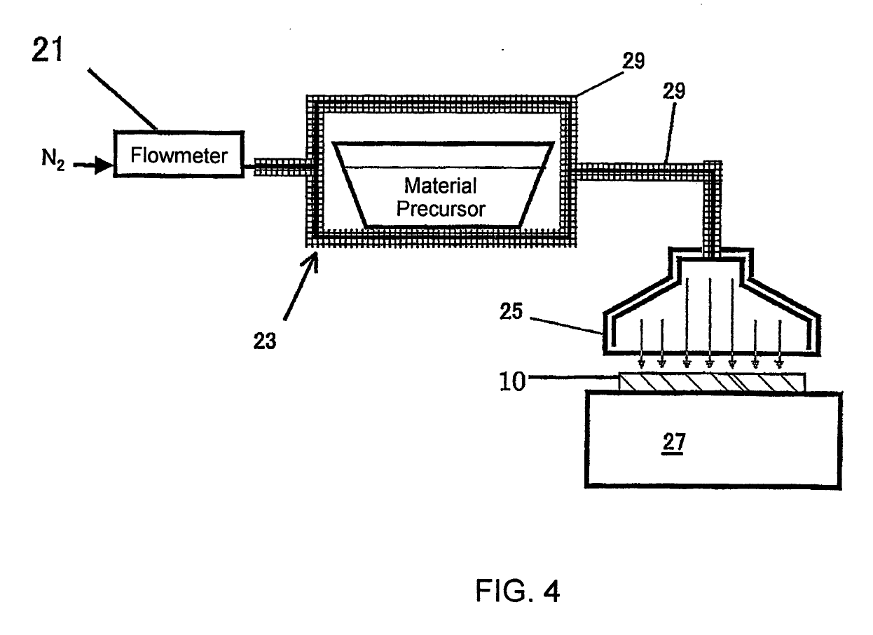

Referring to FIG. 4, a multilayer structural body according to a second embodiment of this invention will be described. The multilayer structural body according to this embodiment is formed using an atmosphere-open thermal CVD apparatus shown in FIG. 4. This CVD apparatus comprises a flowmeter 21, an evaporator 23, and a nozzle 25, wherein a silicon wafer forming a base member 10 is placed on a heater 27 and the illustrated silicon wafer has a diameter of 200 mm. As illustrated, the evaporator 23 and the nozzle 25 are covered by a heater 29.

An organic metal complex containing Y is stored as a material in the evaporator 23 where a nitrogen gas (N₂) is introduced through the flowmeter 21 and this material is evaporated by heating and introduced onto the base member 10 through the nozzle 25. As a result, a Y₂O₃ film is deposited as a deposited film on the silicon wafer forming the base member 10. It has been found that this deposited film exhibits an adhesion strength higher than that of the plasma-sprayed film and, further, the number of adhering particles is smaller as compared with the plasma-sprayed film. That is, in the case of the deposited film, the number of adhering particles having a particle size of 0.2 μm or more was 2/mm² or less and the adhesion strength was 10 MPa or more.

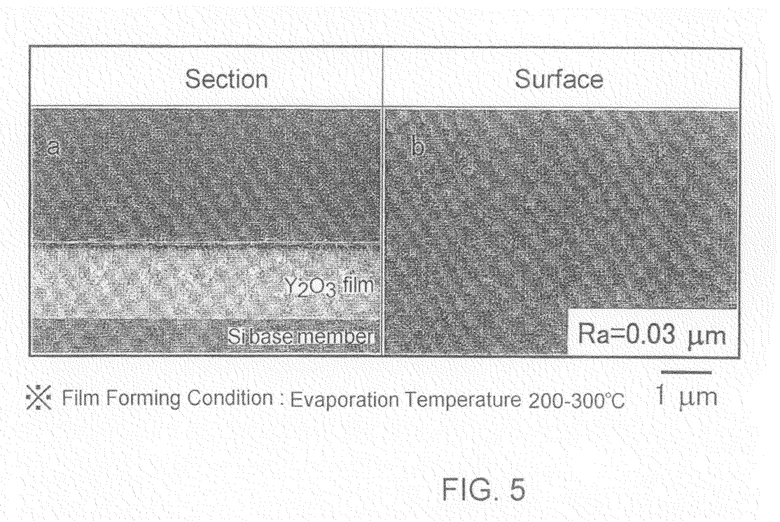

Referring to FIGS. 5(a) and (b), there are shown a section and a surface in the case where a silicon wafer was used as a base member and a Y₂O₃ film was formed on the silicon wafer using the CVD apparatus shown in FIG. 4. The illustrated Y₂O₃ film had a thickness of 2 μm and was formed at an evaporation temperature of 240° C. while the base member 10 was maintained at 500° C. As clear from FIGS. 5(a) and (b), the Y₂O₃ film formed by deposition had a very flat surface. Thus, this sample can be used for evaluation without applying a flattening treatment such as lapping. As a result of applying cleaning by the foregoing method to samples in which film formation was performed on a ceramic base member and a SUS base member, respectively, in the same manner as the film formation on the silicon wafer, it was possible to reduce the number of adhering particles of 0.2 μm or more to 2/mm² or less at an ultrasonic output of 5 W/cm² or more like the sprayed films as shown in Table 1.

Further, using a ceramic as a substrate, a Y₂O₃ film was deposited on the ceramic substrate by a PVD apparatus using an electron beam as a heat source, thereby obtaining a sample. Also in the case of this sample Y₂O₃ film, the very smooth film was obtained like in the case of the foregoing CVD method. As a result of applying cleaning by the foregoing method to samples in which film formation was performed on a silicon wafer base member and an Al base member, respectively, in the same manner as the film formation on the ceramic, it was possible to reduce the number of adhering particles of 0.2 μm or more to 2/mm² or less at an ultrasonic output of 5 W/cm² or more like the sprayed films as shown in Table 1.

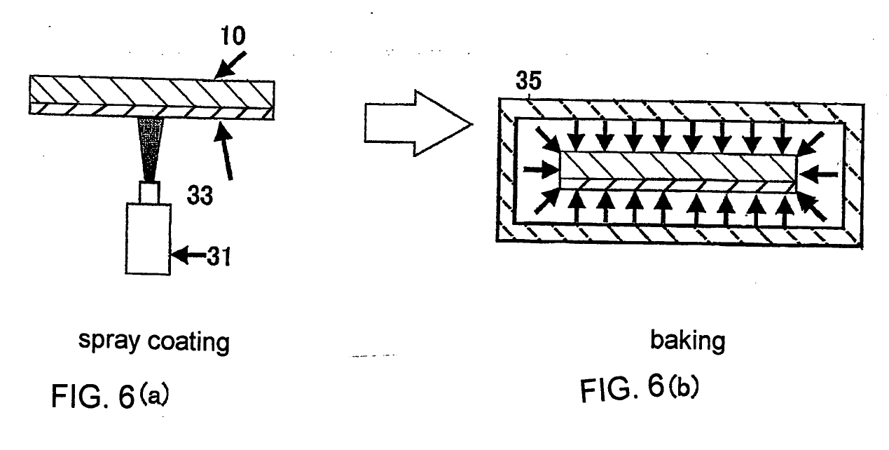

Next, referring to FIGS. 6(a) and (b), a multilayer structural body according to a third embodiment of this invention will be described. The multilayer structural body is obtained by first coating a ceramic precursor 33 on a base member 10 using a spray gun 31 as shown in FIG. 6(a) and then baking them in an oven 35. By baking the precursor 33, formed by the spray gun 31, at a temperature of about 300° C. in the oven 35, there is obtained a high-purity, high-density ceramic film, for example, a Y₂O₃ film. The technique of forming the Y₂O₃ film in this manner is called herein a sol-gel method.

According to this method, it is possible to easily form a high-purity ceramic film at a relatively low temperature. Actually, when a Y₂O₃ film was formed on an aluminum base member 10, there was obtained the Y₂O₃ film having Ra of 0.11 μm when the base member 10 had Ra of 0.18 μm.

In the foregoing example, the description has been given of the case where the precursor is coated by the spray gun 31. However, the precursor may be coated by a dipping method.

In the foregoing embodiments, the description has been given of the case where the Y₂O₃ film is formed. However, it is also applicable in the same manner to the case where another ceramic film such as an Al₂O₃ film is formed. Further, the description has been given of the case where the aluminum alloy, aluminum, or silicon substrate is used as the base member, but use may be made of another metal, a ceramic, or a composite material thereof.

In the foregoing embodiments, the description has been given only of the case where the multilayer structural body according to this invention is used as the member or component of the semiconductor manufacturing apparatus. However, the multilayer structural body according to this invention is not limited thereto but can be applied to each of various apparatuses as a substitute for a ceramic member. Further, it is also applicable to a structural body used as a component or a member for use in an environment where high cleanness is required, such as in the manufacture of medical supplies or the processing/manufacture of foodstuffs, not limited to a semiconductor or liquid crystal manufacturing apparatus or the like.

### INDUSTRIAL APPLICABILITY

As described above, the multilayer structural body according to this invention is not limited thereto but can be applied to each of various apparatuses as a substitute for a ceramic member. It is also applicable to a structural body used as a component or a member for use in an environment where high cleanness is required, such as in the manufacture of medical supplies or the processing/manufacture of foodstuffs, not limited to a semiconductor or liquid crystal manufacturing apparatus or the like.

1. A multilayer structural body comprising a base member and a film formed on a surface of said base member, wherein the number of adhering particles having a particle size of 0.2 μm or more is two or less per mm² on said film.

2. A multilayer structural body according to claim 1, wherein said base member is formed of a ceramic, a metal, or a composite material thereof.

3. A multilayer structural body according to claim 2, wherein said film is a ceramic film.

4. A multilayer structural body according to claim 3, wherein said ceramic film is a sprayed film deposited on said base member by spraying.

5. A multilayer structural body according to claim 3, wherein said film is a ceramic film deposited on said base member by a CVD method.

6. A multilayer structural body according to claim 3, wherein said film is a ceramic film deposited on said base member by a PVD method.

7. A multilayer structural body according to claim 3, wherein said film is a ceramic film deposited on said base member by a sol-gel method.

8. A multilayer structural body according to claim 3, wherein said film is formed on a sprayed film by at least one kind of method selected from a CVD method, a PVD method, and a sol-gel method.

9. A multilayer structural body according to claim 2, wherein said ceramic film has an adhesion strength of 10 MPa or more.

10. A method of cleaning a multilayer structural body, said multilayer structural body comprising a base member and a film formed on a surface of said base member, said method comprising a step of cleaning said film by applying an ultrasonic wave of 5 W/cm² or more and less than 30 W/cm².

11. A method according to claim 10, wherein said ultrasonic cleaning is performed using a nozzle-type cleaning apparatus.

12. A method according to claim 10, wherein said ultrasonic cleaning is performed by preparing a solution in which a gas selected from the group consisting of hydrogen, ammonia, and carbon dioxide is dissolved in ultrapure water, and applying the ultrasonic wave to said solution.

13. A method according to claim 11, wherein said ultrasonic cleaning is performed by preparing a solution in which a gas selected from the group consisting of hydrogen, ammonia, and carbon dioxide is dissolved in ultrapure water, and applying the ultrasonic wave to said solution.
